(19) United States
(12) Patent Application Publication
(10) Pub. No.: US 2009/0004372 A1
(43) Pub. Date: Jan. 1, 2009

(54) Electroless Niwp Adhesion and Capping Layers for Tft Copper Gate Process

(76) Inventors: Akinobu Nasu, Ibaraki (JP); Shyan-Fang Chen, Hsinchu (TW); Yi-Tsung Chen, Hsinchu (TW); Tsu-An Lin, Hsinchu (TW); Chiung-Sheng Hsiung, Hsinchu (TW)

Correspondence Address: AIR LIQUIDE;Intellectual Property, 2700 POST OAK BOULEVARD, SUITE 1800, HOUSTON, TX, 77056, US

(21) Appl. No.: 11/995,312

(22) PCT Filed: Jul. 13, 2005
(86) PCT No.: PCT/EP2005/009175

§ 371 Date: Jun. 9, 2008

(51) Int. Cl. B05D 5/12; C09K 19/52; B32B 17/06

(52) U.S. Cl. 427/126.2; 428/432; 428/1.62

(57) ABSTRACT

Electroless NiWP layers are used for TFT Cu gate process. The NiWP deposition process comprises the following steps. (a) Cleaning of the base surface using for example UV light, ozone solution and/or alkaline mixture solution, (b) micro-etching of the base surface using, e.g. diluted acid, (c) catalyzation of the base surface using, e.g. SnCl<SUB>2</SUB> and PdCl<SUB>2</SUB> solutions, (d) conditioning of the base surface using reducing agent solution, and (e) NiWP deposition. It has been discovered that NiWP layers deposited under certain conditions could provide good adhesion to the glass substrate and to the Cu layer with a good Cu barrier capability. A NiWP layer in useful for adhesion, capping and/or barrier layers for TFT Cu gate process (e.g. for flat screen display panels).

The size of glass substrate is getting larger and larger to produce larger TFT-LCD or plasma panels efficiently. However, as the area increases, it becomes more difficult to achieve uniform displaying of the image since the signal delay at gate lines becomes critical. This is due to the high resistivity of the current gate material (aluminium) and lower resistivity materials such as copper are expected to be used in the future for reduction of this delay. However, metallic copper is not as stable as aluminum. Copper is easy to oxidize and easy to diffuse into other materials. It is known from U.S. Pat. No. 6,413,845 a wet deposition process for TFT Cu gate, using stacked layers of Ni and Au between the glass substrate and the Cu gate layers.

The inventors have evidenced that a layer is required to work as an “adhesion layer” between the Cu layer and the glass substrate said adhesion layer being also a diffusion barrier layer avoiding any Cu diffusion. It is also necessary to provide a “capping layer” on the top of the Cu layer to avoid Cu diffusion in the above layer.

It is known to use electroless NiWP as a Cu barrier, from the article of Osaka et al entitled “Electroless Nickel Ternary alloy deposition on SiO₂ for application to diffusion barrier layer in copper interconnect technology” Journal of the Electronical Society—149 (11-2002): however the films disclosed in this document, show a lack of adhesion to the glass substrate and a poor thickness uniformity, under the process conditions as disclosed in this document.

U.S. Pat. No. 6,413,845 discloses stacked-layers (Ni and Au layers): however, this process requires multi-step depositions with corresponding resist processes which increase the cost of manufacture of the final TFT display panel.

Deposition of adhesion and/or capping layers have been proposed using a dry process such as PVD and CVD. However, these dry processes are expensive in terms of equipment, especially the tool cost which increases drastically with the panel size. This is getting very critical for panel manufacturers since one of the key reasons to increase the glass substrate area is to reduce production cost.

There is accordingly still today an issue to be resolved by the man skilled in the art, to define a process which does not increase the cost of depositing the diffusion barrier layer, which provides good adhesion to the glass substrate and which is preferably applicable to the capping layer deposition process of the copper layer.

According to the invention, electroless NiWP layers deposited under certain conditions were found to be suitable for making both adhesion and capping layers with a good Cu barrier capability. The roughness and thickness uniformity of these layers were also found to be satisfactory.

The inventors have discovered that the NiWP plating conditions may lead to variable contents of Ni, W and/or P elements in the NiWP film, with important consequences for the film characteristic, including the copper layer characteristics.

Tungsten atoms in the NiWP film improve thermal and barrier properties, but other refractory metals such as molybdenum and rhenium can also be used, instead of W.

The electroless process, according to the invention, reduces the production cost and also simplifies the deposition process compared to the current dry processes used today for a similar purpose.

The preferred deposition process of NiWP according to the invention comprises a combination of the following steps:

(a) Cleaning of base surface:
Preferably, ultraviolet light, ozone solution and/or a de-greasing solution such as a mixture of NaOH, Na₂CO₃, Na₃PO₄ are used to clean the glass surface (removal of organic contaminates on the surface).
It is possible to skip this step when the surface is clean enough or if these treatments may cause damages or unexpected chemical reactions.
This step is carried out for a certain duration, typically, 10 sec to 10 min for UV and ozone treatment, more preferably 30 sec to 3 min for each. When using the de-greasing solution, the duration may last from 30 sec to 10 min at a temperature of 30 C to 100 C, more preferably from 1 min to 5 min at a temperature of 50 C to 90 C.
(b) Micro-etching of the base surface:
A diluted acid solution such as HF solution is used. This step makes micro roughness on the glass substrate for deposition of an adhesion layer, and this step enhances the adhesion of the NiWP layer to the substrate eventually. It is however possible to skip this step, when the surface has already a certain roughness or if this treatment causes unexpected and detrimental reactions on the surface.
Typically, this step is carried out for 10 sec to 5 min with a diluted solution of 0.1% to 5% HF or HNO₃ in deionized water, more preferably 30 sec to 3 min with a 0.3% to 3% vol. HF solution.

### (c) Catalyzation.:

SnCl₂ and/or PdCl₂ solutions are usually used. This step is carried out to provide an ultra thin Palladium layer on surface. The substrate is first immersed in SnCl₂ solution (or similar) then immersed in a PdCl₂ solution (or similar) after rinsing. This step can be repeated several times if the desired thickness of the Pd layer on the surface is not achieved in one step. It is however possible to skip this step when this treatment causes unexpected reaction at surface.
Typically, solutions containing 0.1 g/L to 50 g/L of SnCl₂ in 0.1% to 10% vol. HCl and 0.01 g/L to 5 g/L of PdCl₂ in 0.01% to 1% vol. HCl are used, more preferably 1 g/L to 20 g/L of SnCl₂ in 0.5% to 5% HCl and 0.1 g/L to 2 g/L of PdCl₂ in 0.05% to 0.5% HCl solutions.
By carrying out this step, it is expected to obtain the following chemical reaction at the surface: Sn²⁺+Pd²⁺=>Sn⁴⁺+Pd.

### (d) Conditioning.:

An aqueous solution containing a reducing agent is used. It was discovered that this step is critical to obtain a NiWP deposition after the catalyzation step (c). The pH of the solution is preferably adjusted to the same value as the pH value of the NiWP plating solution used in step (c).This step may reduce oxidative Sn⁴⁺ on the surface, and promote reductive NiWP deposition chemistry. Preferably the solution of step (d) is similar to the solution of step (e) that solution of step (d) does not contain any Ni and W. As an alternative, it is possible to use a NaH₂PO₂ solution only. This conditioning step may preferably last for 10 sec to 3 min.
(e) Electroless NiWP deposition on glass substrate and or on Cu:
Preferably, a solution containing NiSO₄, Na₂WO₄ and/or NaH₂PO₂ is used as a source of Ni, W and P, respectively. NaH₂PO₂ is a reducing agent. Tri-sodium citrate and (NH₄)₂SO₄ may also be added to the solution and are respectively used as a complex formation agent and a pH buffer. H₂SO₄, NaOH and/or NH₄OH can also be used to adjust the pH of the solution if necessary. The temperature and pH of the bath solution are in the range of 50 C to 100 C and 5 to 11, respectively, more preferably, in the range of 60 to 90 C and 7 to 10 respectively. The plating time can be determined by the deposition rate and the thickness of the layer, typically between 15 sec to 5 min for 50 nm NiWP layer thickness.

The invention will be now better understood with the following examples and comparative examples.

### EXAMPLE 1

A bare glass substrate was dipped into a de-greasing solution comprising NaOH, Na₂CO₃, Na₃PO₄ (within the respective proportions defined hereabove) for 3 min at 80 C in order to remove organic contaminants. After rinsing with de-ionized water (DIW), it was dipped into diluted HF solution (2.5%) for 1 min to create micro roughness on the surface. After rinsing, it was immersed into a SnCl₂ solution (10 g/L SnCl₂ in 1% HCl), and then immersed into a PdCl₂ solution (0.3 g/L PdCl₂ in 0.1% HCl) for 2 min each. After rinsing, it was dipped for 30 sec into a conditioning solution at room temperature and within a pH=7 containing a reducing agent and having the following composition:

NaH₂PO₂H₂O: 20 g/L, (NH₄)₂SO₄: 30 g/L, Tri-sodium citrate 2H₂O: 70 g/L

Then, it was dipped into NiWP plating solution at 60° C. at pH7, having the following composition:

NiSO₄ 6H₂O: 20 g/L, Na₂WO₄ 2H₂O: 30 g/L, NaH₂PO₂H₂O: 20 g/L, (NH₄)₂SO₄: 30 g/L, Tri-sodium citrate 2H₂O: 70 g/L.

The deposited films showed good adhesion to the glass substrate. The roughness (Ra) and the thickness uniformity of the layers were satisfactory (less than 5 nm and within 5%, respectively). The deposition rate was about 3 nm/min as typical.

The NiWP film consists of 85 wt % Ni, 5 wt % of W and 10 wt % of P.

X-ray analysis revealed that the NiWP layer was made of an amorphous material. Changes of these characteristics was only slight even after heating said layer at 400 C for 1 hour.

The NiWP layer was deposited on Cu in a similar manner to that used on the glass substrate. The deposited NiWP film showed good adhesion to the Cu with satisfactory roughness and thickness uniformity.

Electroless Cu layer was deposited on the electroless NiWP layer above (already deposited on the glass substrate). Then, the layers were heated at 400 C for 1 hour. X-ray analysis revealed that the diffusion of Cu into the NiWP was only slight after the heating and that good adhesion exist with the glass substrate which confirm that this layer was adequate for Cu layer adhesion, Cu layer capping and had an effective barrier effect in both cases (of course, it may also be used for one propose only: adhesion or capping or barrier).

### COMPARATIVES EXAMPLES

All these examples are made in similar conditions to Example 1, except as provided hereinbelow:

### Comparative Example 1

A Cu layer was deposited on the glass substrate without intermediary NiWP layer. The layer showed poor adhesion and was peeled off easily.

### Comparative Example 2

A NiWP layer was deposited on the glass substrate as in Example 1 except that the cleaning step (a) was not carried out. The deposited film showed poor uniformity and reproducibility.

### Comparative Example 3

A NiWP layer was deposited on the glass substrate as in Example 1 except that the microetching step (b) was not carried out. The deposited film showed poor adhesion on the glass substrate.

### Comparative Example 4

A NiWP layer was deposited on the glass substrate as in Example 1 except that the catalyzation step (c) was not carried out. No deposition was observed on the glass substrate.

### Comparative Example 5

A NiWP layer was deposited on the glass substrate as in Example 1 except that the conditioning step (d) was not carried out. The deposited film showed poor uniformity and reproducibility.

### Comparative Example 6

A NiWP layer was deposited on glass substrate as in Example 1 except that the temperature of the NiWP deposition bath was set below 50 C. The deposited film showed a poorer uniformity and reproducibility, compared to the same experience ran at bath temperature above 50° C., all conditions being otherwise similar.

### Comparative Example 7

A NiWP layer was deposited on the glass substrate as in Example 1, except that the pH of the NiWP deposition bath was adjusted to a value higher than 11. The deposited film showed a poorer adhesion than in the case of a pH between 5 to 11, all other conditions being similar.

### Comparative Example 8

A NiWP layer was deposited on the glass substrate as in Example 1 except that the pH of step (d) and step (e) solutions were adjusted at different values. The deposited film showed poorer uniformity.

### Example 2

A NiWP layer was deposited on a glass substrate and then in turn, a Cu layer was deposited as the NiWP layer as disclosed in Example 1, except that the composition of the solution used in step (e) comprises an amount of 10 g/L of NiSO₄ 6H₂O instead of 20 g/L. The deposited film showed good adhesion to the glass substrate and the Cu layer had a satisfactory roughness and thickness uniformity. The NiWP film comprised 81 wt % Ni, 7 wt % of W and 12 wt % of P.

X-ray analysis revealed that the NiWP layer was made of an amorphous material. Changes of these characteristics was only slight even after heating these layers at 400 C for 1 hour, while a negligible Cu diffusion into the NiWP was observed.

### Example 3

A NiWP layer was deposited on a glass substrate and then, in turn, a Cu layer was deposited on the NiWP layer as Example 1 except that the amount of Tri-sodium citrate 2H₂O was equal to 35 g/L and that the bath temperature was 90 C when carrying out step (e). The deposited film had a good adhesion to the glass substrate and the Cu layer had a better roughness and thickness uniformity than in Example 1. The NiWP film was consisting of 94 wt %, Ni, 2 wt % of W and 4 wt % of P.

X-ray analysis revealed that the NiWP layer was made of a partially crystalline material. Changes of these characteristics were only slight even after heating at 400 C for 1 hour, while a negligible Cu diffusion into the NiWP layer was observed.

### Example 4

A NiMoP and a Cu layers were deposited on a glass substrate as in Example 1 except that Na₂MoO₄ was used instead of Na₂WO₄. The composition of the conditioning solution was as follows

NaH₂PO₂H₂O: 20 g/L, NH₄Cl: 50 g/L, Tri-sodium citrate 2H₂O: 85 g/L

This solution had a pH of 9 and was maintained at room temperature.

The NiMoP plating bath used had the following composition:

NiSO₄ 6H₂O: 35 g/L, Na₂MoO₄: 0.15 g/L, NaH₂PO₂H₂O: 20 g/L, NH₄Cl: 50 g/L, Tri-sodium citrate 2H₂O: 85 g/L.

The pH of the solution was equal to 9, while the solution was maintained at a temperature of 62 C. The deposited films showed good adhesion to the glass substitute and the Cu layer. The roughness and thickness uniformity of the layers were satisfactory. The deposition rate was about 2 nm/min as typical. The NiMoP film was essentially consisting of 81 wt % Ni, 2 wt % Mo and 17 wt % P.

X-ray analysis revealed that the NiMoP layer was amorphous. Changes of these characteristics were only slight even after heating at 400 C for 1 hour. The X-ray analysis also revealed that the diffusion of Cu into the NiMoP was only slight even after the heating.

### Example 5

A NiReP was deposited on a glass substrate and on a Cu layer as in Example 1, except that (NH₄)₂ReO₄ was used instead of Na₂WO₄.

The conditioning solution had the following compositions:
NaH₂PO₂H₂O: 20 g/L, (NH₄)₂SO₄: 30 g/L, Tri-sodium citrate 2H₂O: 85 g/L
The pH of the solution was equal to 9, and the solution maintained at room temperature.

The NiReP plating bath used had the following composition:

NiSO₄ 6H₂O: 35 g/L, (NH₄)₂ReO₄: 0.5 g/L, NaH₂PO₂H₂O: 20 g/L, (NH₄)₂SO₄: 30 g/L, Tri-sodium citrate 2H₂O: 85 g/L.

The pH of the solution was equal to 9 while the temperature of the solution was maintained to 70 C.

The deposited films showed good adhesion to glass and Cu. The roughness and thickness uniformity of the layers were satisfactory. The NiReP film was essentially consisting of 71 wt % Ni, 23 wt % of Re and 6 wt % of P.

1-8. (canceled)

9. A method of depositing a NiMP layer on a substrate such as glass and/or copper, M being an organo metallic molecule selected from the group comprising W, Mo, Re, comprising the steps of:
a) optionally cleaning the substrate,
b) optionally micro etching the substrate,
c) depositing a catalyzation layer on the substrate,
d) conditioning the substrate with a conditioning solution,
e) depositing a NiMP layer on the substrate by contacting said substrate or some portion thereof with a bath mixture comprising precursors of Ni, M and/or P in order to obtain a layer comprising between 55% to 96% wt Ni, 3% to 20% wt P and 1% to 25% wt M.

10. The method of claim 9, wherein the pH value of the conditioning solution is comprised between 5 to 11.

11. The method of claim 9, wherein the pH value of the bath mixture is comprised between 5 to 11.

12. The method of claim 10, wherein the pH values of the conditioning solution and the bath mixture solution are substantially the same.

13. The method of claim 8, wherein the temperature of the conditioning solution is close to room temperature or equal to room temperature.

14. The method of claim 9, wherein the temperature of the bath mixture is higher than 50° C.

15. An interconnection device using copper connections deposited on a glass substrate wherein a NiMP layer is deposited on the glass substrate and/or on the copper connections in accordance with the process of claim 9.

16. A TFT-LCD or plasma display panel comprising an interconnection device according to claim 9.
